(19) United States
(12) Patent Application Publication
(10) Pub. No.: US 2006/0229811 A1
(43) Pub. Date: Oct. 12, 2006

(54) Vehicle navigation system

(76) Inventors: Daren W. Herman, Isanti, MN (US); John W. Callahan, St. Paul, MN (US)

Correspondence Address: BAKER & DANIELS LLP, 300 NORTH MERIDIAN STREET, SUITE 2700, INDIANAPOLIS, IN, 46204, US

(21) Appl. No.: 11/103,680

(22) Filed: Apr. 12, 2005

(51) Int. Cl. G01C 21/00

(52) U.S. Cl. 701/213; 701/200

(57) ABSTRACT

A vehicle navigation system that includes a vehicle mounted data display and a portable global positioning system (“GPS”) unit that may interface with the vehicle mounted data display.

### FIELD

Embodiments of the invention relate to a vehicle navigation system that includes a vehicle mounted data display and a portable global positioning system (“GPS”) unit that may interface with the vehicle mounted data display.

### BACKGROUND SECTION

Global positioning systems, or GPSs, use information received from a network of satellites and stored or loaded map information to help users of the systems navigate. GPS systems may be made very compact and portable and may have sophisticated functionality. The combination of the satellite information and map information allows users to understand their current position on a map, plot a course to a desired location, retrace a previously traveled path, and perform other useful navigational tasks. Applications of GPSs have even been used to control a vehicle's speed and navigation.

As GPS technology develops, its use is becoming more widespread. Use of GPS units in recreational applications is increasing dramatically, but there are many obstacles to overcome.

### BRIEF SUMMARY OF THE INVENTION

One embodiment of the present invention includes a vehicle navigation system with a vehicle having a vehicle mounted data display attached to the vehicle that is viewable by an operator of the vehicle. This embodiment may include a portable GPS unit having a GPS sensor capable of sensing the location of the GPS unit and a portable display. A mounting point on the vehicle is configured for mounting the GPS unit so that the portable data display is viewable by the operator of the vehicle. This embodiment also includes a data interface between the portable GPS unit and the vehicle mounted display so that data from the portable GPS unit may be displayed on the vehicle mounted display.

Another embodiment of the present invention includes a vehicle navigation system with a vehicle having a vehicle mounted data display attached to the vehicle that is viewable by an operator of the vehicle. This embodiment may include a portable GPS unit having a GPS sensor capable of sensing the location of the GPS unit and a portable display. A mounting point on the vehicle is configured for mounting the GPS unit so that the portable data display is viewable by the operator of the vehicle. This embodiment also includes a data interface between the portable GPS unit and the vehicle mounted display so that data from the portable GPS unit may be displayed on the vehicle mounted display. The data interface of this embodiment also allows data from the vehicle to be displayed on the portable display unit.

In another embodiment of the present invention, a vehicle navigation system includes a vehicle having a vehicle mounted data display attached to the vehicle that is viewable by an operator of the vehicle. This embodiment may include a portable GPS unit including a GPS sensor capable of sensing the location of the GPS unit and a portable display. A mounting point on the vehicle is configured for mounting the GPS unit so that the portable data display is viewable by the operator of the vehicle. This embodiment also includes a data interface between the portable GPS unit and the vehicle mounted display so that data from the portable GPS unit may be displayed on the vehicle mounted display. In this embodiment the vehicle further includes an input device that is configured to send a signal to the GPS unit through the data interface.

In another embodiment of the present invention, a vehicle navigation system includes a vehicle having a vehicle mounted data display attached to the vehicle that is viewable by an operator of the vehicle. This embodiment may include portable GPS unit including a GPS sensor capable of sensing the location of the GPS unit and a portable display. A mounting point on the vehicle is configured for mounting the GPS unit so that the portable data display is viewable by the operator of the vehicle. This embodiment also includes a data interface between the portable GPS unit and the vehicle mounted display so that data from the portable GPS unit may be displayed on the vehicle mounted display. In this embodiment the vehicle further includes an input device that is configured to send a signal to the GPS unit through the data interface. The vehicle has hand-operated vehicle steering controls for controlling the operation of the vehicle and the input device is located so that the operator may activate it without removing a hand from the vehicle steering controls.

### BRIEF DESCRIPTION OF THE DRAWINGS

FIG. 1 is a block flow diagram of an embodiment of the invention.

FIG. 2 is a representation of sample displays in accordance with an embodiment of the invention.

FIG. 3 is a perspective view of a vehicle in accordance with an embodiment of the invention.

FIG. 4 is a rear plan view of a vehicle in accordance with an embodiment of the invention.

FIG. 5 is a perspective view of a vehicle in accordance with an embodiment of the invention.

FIG. 6 is a perspective view of a vehicle in accordance with an embodiment of the invention.

### DETAILED DESCRIPTION OF EMBODIMENTS OF THE INVENTION

Global positioning systems, or GPSs, have become increasingly popular with advances in technology. GPS systems are now very portable and lightweight as well as user friendly. Handheld units such as the Garmin® GPSmap76S and others allow users to navigate while traveling by vehicle or otherwise, and allow the units to be used in more than one vehicle.

A network of GPS satellites transmit satellite data to GPS units. GPS units take this information and use triangulation to calculate the unit's location. If the GPS unit is equipped with stored mapping information, the GPS display may show the unit's location on a map.

A GPS unit must be receiving the signal of at least three satellites to calculate a unit's latitude and longitude and track movement. When receiving signals from four or more satellites, the receiver can determine the unit's latitude, longitude, and altitude, or three-dimensional position. Once the user's position has been determined, a GPS unit may be configured to calculate other information, such as speed, bearing, track, trip distance, distance to destination, sunrise and sunset time and more.

GPS units may record locations as “waypoints.” Waypoints may be stored in the GPS unit as goals to reach during a journey. Waypoints relating to the current location of the unit may be stored at various points throughout a journey to allow backtracking or review of a route. The storing of waypoints may be accomplished manually by an operator of a unit or automatically by the unit, for example at a routine interval.

Several embodiments of the invention relate to a vehicle navigation system that includes a vehicle with a vehicle mounted data display that is viewable by the operator of the vehicle. There is a portable GPS unit including a GPS sensor capable of sensing the location of the GPS unit. The portable GPS unit also has a portable display for displaying information to the user, possibly including the user's location, elevation, heading, distance to a predetermined location, time to a predetermined location, and other items of interest. The portable GPS unit may be used independently of the vehicle if the user is walking or using some form of transportation other than the vehicle. In some embodiments there is a mounting point on the vehicle for the portable GPS unit. The mounting point may be configured to mount the portable GPS unit so that the portable display is viewable by the operator of the vehicle. There may be a data interface so that data from the portable GPS unit may be conveyed to the vehicle mounted display for display. It would be possible in some of these embodiments to allow communication through the data interface to go two ways and have data from the vehicle displayed on the portable display. It may also be possible for an input device located at the vehicle display to send a signal through the data interface to the GPS unit.

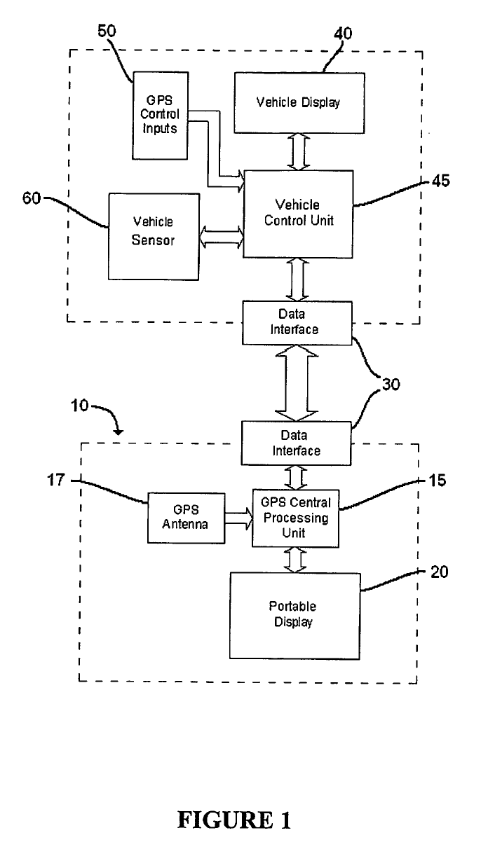

Turning now to the figures, FIG. 1 is a block flow diagram of an embodiment of the invention. GPS unit 10 includes GPS navigation programming and features in a central processing unit 15 and a GPS antenna 17 capable of receiving signals from global positioning satellites. GPS unit 10 operates in conjunction with portable display 20 which may be used to view data associated with GPS unit 10. GPS unit 10 and portable display 20 together comprise a portable navigation unit which may be carried by a user who is traveling in a vehicle, by foot, or from vehicle to vehicle. The GPS central processing unit may perform calculations and store information to be retrieved by the GPS unit or the user.

The GPS unit of this invention may be linked via data interface 30 to a vehicle mounted data display 40 in accordance with embodiments of the invention. Data interface 30 could be an RS-232 port with associated wiring or any other type of wired porting (e.g. serial, parallel or USB), a wireless interface (e.g. Bluetooth® technology Wi-Fi, infrared, or RF), or any other data interface or protocol known in the art. Vehicle information from vehicle sensor 60 may also be displayed on the vehicle mounted data display 40 or may be transmitted through data interface 30 to the portable display 20 for display. Vehicle control unit 45 of this embodiment acts as a central processing unit for the vehicle sensors 60, vehicle mounted data display 40, input device 50, and data interface 30. In these instances, data interface 30 may be configured for two-way communication to allow GPS data from the GPS unit 10 to be displayed on the vehicle mounted data display 40 and vehicle data from the vehicle sensors 60 to be displayed on the portable display 20. Vehicle sensor 60 may be a vehicle speed sensor, an engine speed sensor, a transmission gear sensor, an engine temperature sensor, an engine diagnostic sensor, a fuel level sensor, a brake sensor, a headlight or high beam sensor, an oil level sensor, an oil pressure sensor, or any other vehicle sensor commonly known in the art.

Input device 50 may transmit signals at the operator's initiation from the vehicle to the GPS unit 10. For example, the operator could decide to set a waypoint at a current location by activating input device 50. Another example would be an operator starting an automatic recording of sequential waypoints at predetermined time intervals by activating the input device 50. This is commonly referred to as “breadcrumbing,” and allows the user to automatically store a representation of the route traveled in the GPS unit. Yet another example would be activating input device 50 to plot a return route along a path defined by previously stored waypoints.

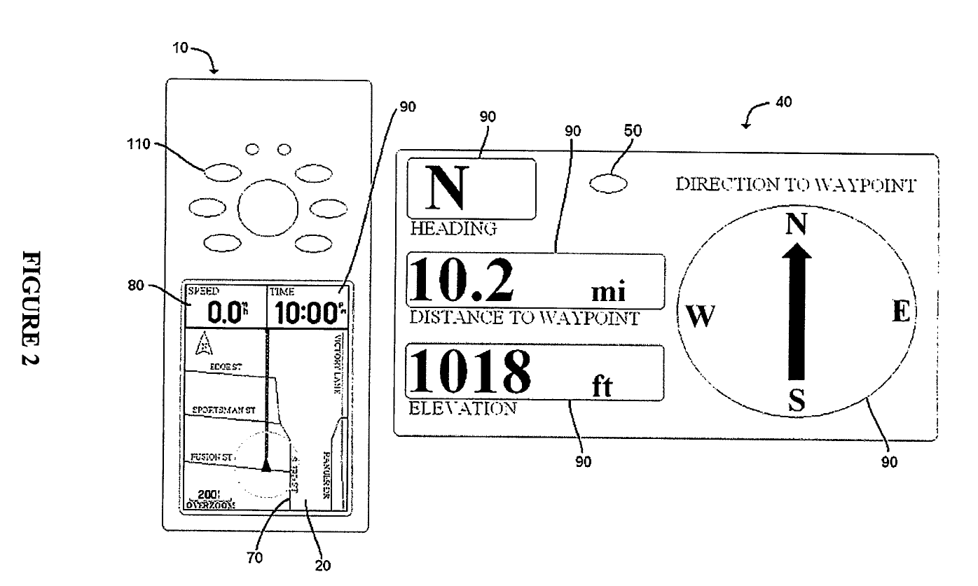

FIG. 2 is a representation of sample displays in accordance with an embodiment of the invention. In this case the portable GPS unit 10 includes portable display 20. Portable GPS unit 10 may include portable input device 110 for inputting data into the unit 10, whether on a vehicle or not. The portable display 20 may display map information 70, vehicle information 80, and GPS information 90. FIG. 2 includes a representation of a vehicle mounted data display 40. The vehicle mounted data display in this case shows GPS information 90 that has been transmitted from the GPS unit 10 through a data interface 30 (not shown). The vehicle mounted data display may also show vehicle sensor 60 information as well. The vehicle mounted data display 40 of this embodiment also includes an input device 50 located on the vehicle mounted data display that may be used to transmit data to the portable GPS unit 10. By making both the portable display 20 and the vehicle mounted display 40 viewable at the same time by an operator of the vehicle, embodiments of the invention make possible the display of a large and diverse amount of information for the operator's consideration.

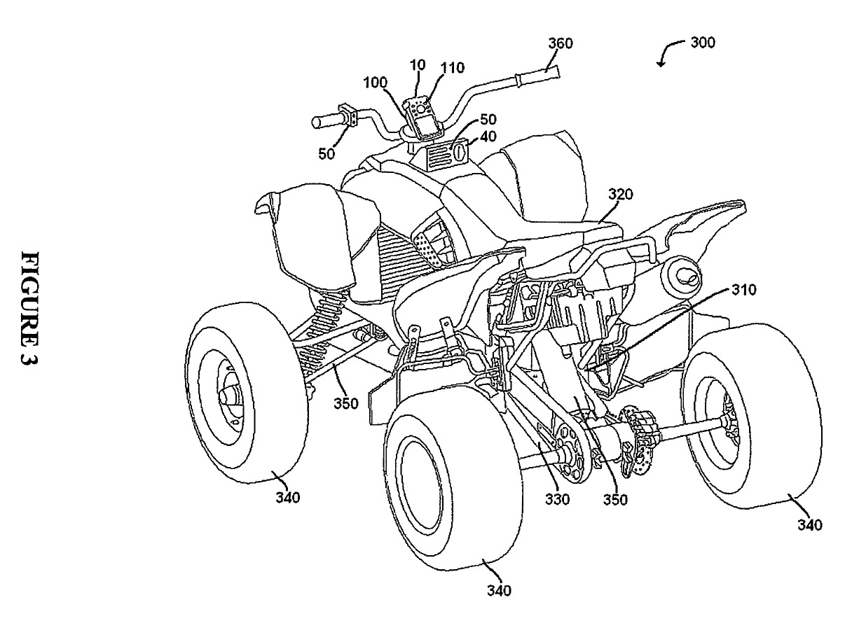

FIG. 3 is a perspective view of a vehicle in accordance with an embodiment of the invention. A vehicle 300 has a frame 310 that supports or mounts several components, including an engine, a straddle-type seat 320, at least one drive train 330, and wheels 340 suspended from an active suspension 350. The seat 320 is adapted to accommodate a rider in a straddle fashion, and the engine powers the drive train 330 to propel the vehicle 300. Handlebars 360 are operably connected to a pair of wheels 340 to effect steering. Also included in the embodiment of FIG. 3 is a vehicle mounted data display 40 viewable by the operator of the vehicle when seated on the seat 320. Mounted on handlebars 360 of this embodiment is an input device 50 that may be activated by the operator without removing a hand from the handlebars 360. Input device 50 may consist of one or more switches or buttons that allow the operator to store waypoints in the GPS unit 10, activate “breadcrumbing” by the GPS unit 10, or perform other functions defined by the system. Additionally, or alternatively, an input device 50 may be located elsewhere on the vehicle. The vehicle mounted data display 40 may have an input device 50 mounted thereon that can also be used to transfer data to the GPS unit 10. These locations for the input device are merely exemplary and other locations will occur to one of ordinary skill in the art upon reading this disclosure and are contemplated within the scope of the appended claims. A GPS unit 10 may be mounted on a mounting point 100 in a fashion such that the portable display 20 is also viewable by an operator of the vehicle while seated on the seat 320. The GPS unit 10 may include a portable input device 110.

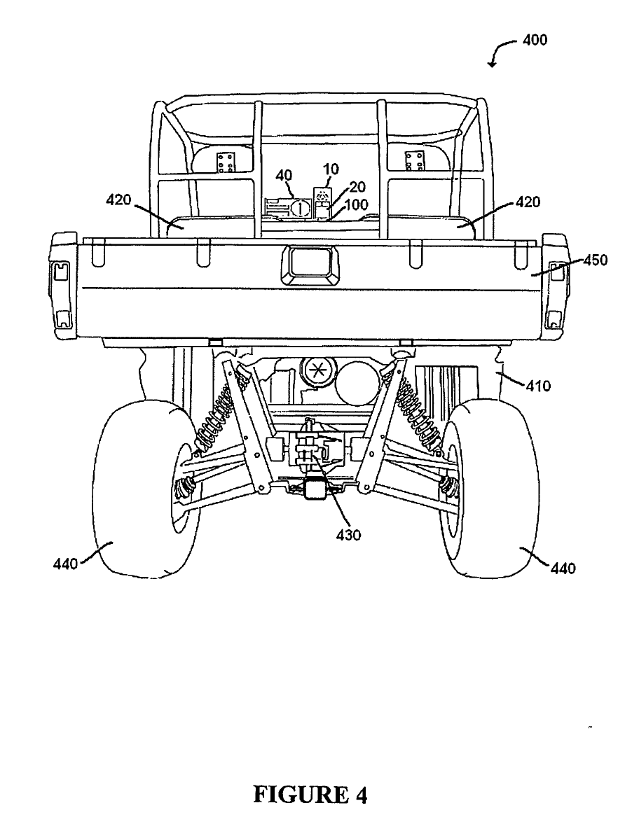

FIG. 4 is a rear plan view of a vehicle in accordance with an embodiment of the invention. Vehicle 400 includes frame 410 that supports and mounts several vehicle components including an engine, side-by-side seats 420, at least one drive train 430, and wheels 440. The vehicle in the embodiment of FIG. 4 also includes a cargo bed 450 for transporting heavy or cumbersome loads. The seats 420 are adapted to accommodate an operator and a passenger in a side-by-side fashion, and the engine powers the drive train 430 to propel the vehicle 400. The vehicle of the embodiment in FIG. 4 also includes a vehicle mounted data display 40. The vehicle of the embodiment of FIG. 4 also includes a mounting point 100 to which may be mounted a GPS unit 10. When the GPS unit 10 is mounted on the mounting point 100, the portable data display 20 is visible to the operator of the vehicle seated in seat 420. Since the vehicle mounted data display is also viewable by the operator when seated in seat 420, the benefit of both displays may be realized when the portable GPS unit 10 is mounted on the mounting point 100. The embodiment also includes a data interface 30 (not shown) and an input device 50 (not shown). The input device 50 is located on a steering wheel (not shown) in a position so as to be activatable by the operator of the vehicle without removing a hand from the steering wheel.

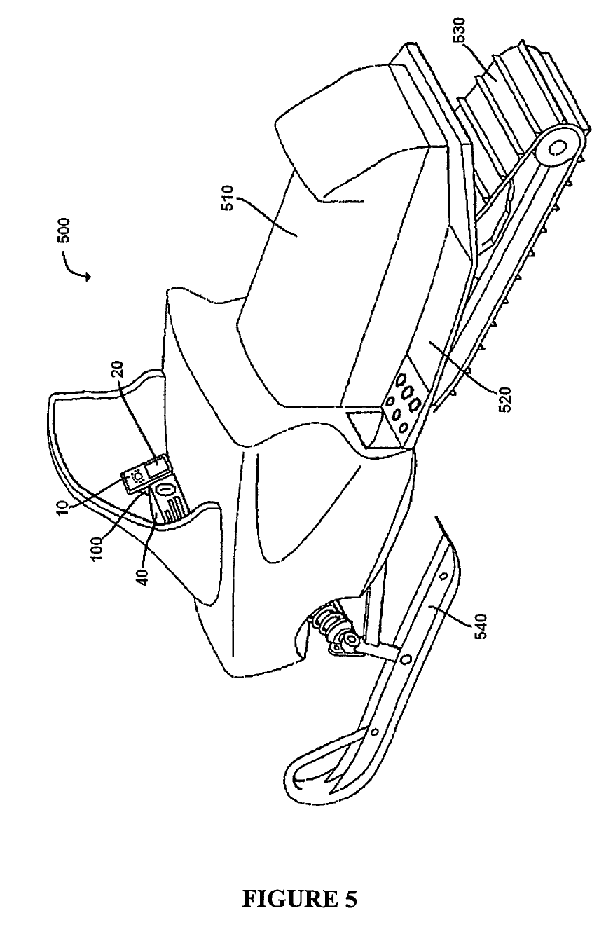

FIG. 5 is a perspective view of a vehicle in accordance with an embodiment of the invention. Vehicle 500 includes a chassis or frame which supports and mounts several vehicle components including an engine, a straddle-type seat 510, running boards 520, at least one drive element such as a drive track 530, and a pair of ground-engaging skis 540. A seat 510 is adapted to accommodate a rider in a straddle fashion and the engine powers the drive track 530 to propel the vehicle 500. The vehicle mounted data display 40 is included and is viewable by an operator of the vehicle when seated on the straddle-type seat 510. A mounting point 100 allows for the mounting of a portable GPS unit 10 to the vehicle 500 in a fashion such that the portable data display 20 of the portable GPS unit 10 is viewable by an operator of the vehicle when seated on the seat 510.

In some embodiments, the portable GPS unit may be connected to the data interface while not being mounted on a mounting point 100. In these embodiments the portable GPS unit may be located in an operator's clothing (e.g., pocket), attached to the operator via a belt clip or bracket, in a storage compartment of the vehicle, or in any other location proximate to the vehicle mounted data display. The portable GPS unit so located may be connected to the data interface either with wires or wirelessly.

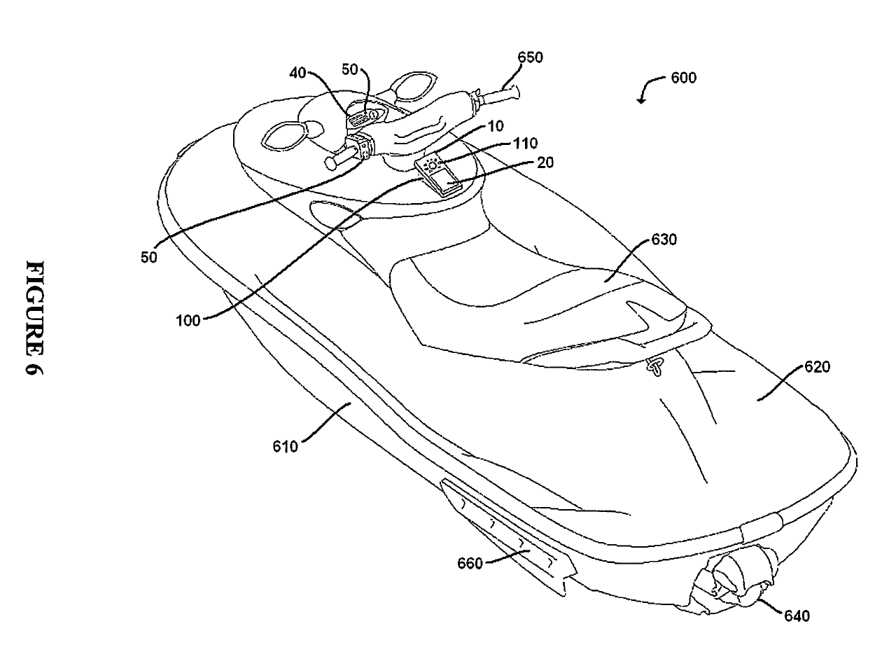

FIG. 6 is a perspective view of a vehicle in accordance with an embodiment of the invention. The vehicle 600 of FIG. 6 includes a hull 610 that supports a deck 620 that in turn supports a straddle-type seat 630. An engine drives a pump which discharges a jet of pressurized water through a drive nozzle 640 to propel vehicle 600 through the water. Handlebars 650 may be operably connected to the jet 640 to turn the vehicle with assistance from the stabilizing sponsons 660. The vehicle includes a vehicle mounted data display 40 viewable by an operator of the vehicle when seated at the seat 630. This embodiment includes a mounting point 100 to which a portable GPS unit 10 may be mounted. When the portable GPS unit 10 is mounted on the mounting point 100 the portable data display 20 is viewable by an operator of the vehicle seated on seat 630. Vehicle 600 also includes input device 50 which may be used to transmit data to the portable GPS unit 10 without removing the operator's hands from the handlebars 650. Examples of data which may be input by the data input device 50 include a signal to mark the existing location, a signal to begin sequential storing of locations at timed intervals (breadcrumbing), or a signal to begin back-tracking a current route from previously stored locations. This data may alternatively be input through portable input device 110 or an input device 50 located elsewhere on the vehicle, for example on the vehicle mounted display unit 40.

While preferred embodiments of the present invention have been described, it should be understood that various changes, adaptations and modifications may be made therein without departing from the spirit of the invention and the scope of the appended claims.

What is claimed is:

1. A vehicle navigation system comprising;
a. a vehicle;
b. a vehicle mounted data display attached to the vehicle and viewable by an operator of the vehicle;
c. a portable GPS unit including a GPS sensor for sensing the location of the GPS unit and also including a portable display;
d. a mounting point on the vehicle configured for mounting the GPS unit so that the portable data display is viewable by the operator of the vehicle; and
e. a data interface between the portable GPS unit and the vehicle mounted display so that data from the portable GPS unit may be displayed on the vehicle mounted display.

2. The vehicle navigation system of claim 1, wherein the data interface further comprises a serial port and wires.

3. The vehicle navigation system of claim 2, wherein the serial port further comprises a RS-232 port.

4. The vehicle navigation system of claim 1, wherein the data interface comprises a wireless interface.

5. The vehicle navigation system of claim 1, wherein the data interface allows data from the vehicle to be displayed on the portable display.

6. The vehicle navigation system of claim 1, wherein the vehicle further comprises an input device that is configured to send a signal to the GPS unit through the data interface.

7. The vehicle navigation system of claim 6, further comprising vehicle steering controls for controlling the steering operation of the vehicle, wherein the input device is located so that the operator may activate it without removing a hand from the vehicle steering controls.

8. The vehicle navigation system of claim 6, wherein the input device is located on the vehicle mounted data display.

9. The vehicle navigation system of claim 1, wherein the GPS unit further comprises a central processing unit for storing a plurality of locations.

10. The vehicle navigation system of claim 9, further comprising vehicle steering controls for controlling the steering operation of the vehicle and an input device that is configured to send a signal to the GPS unit through the data interface, wherein the input device is located so that the operator may activate it without removing a hand from the vehicle steering controls and the input device is configured to send a signal to the GPS unit to store the location of the GPS unit in the central processing unit.

11. The vehicle navigation system of claim 9, wherein a navigation program is stored on the central processing unit.

12. The vehicle navigation system of claim 10, wherein the central processing unit compares the location of the GPS unit to the stored locations.

13. The vehicle navigation system of claim 11, wherein the navigation program includes pre-determined locations.

14. The vehicle navigation system of claim 13, wherein the central processing unit compares the location of the GPS unit to the predetermined locations.

15. The vehicle navigation system of claim 1, wherein the vehicle mounted display and the portable display display different information about the location of the GPS unit.

16. The vehicle navigation system of claim 12, wherein the vehicle mounted display and the portable display display different information about the location of the GPS unit relative to the stored locations.

17. The vehicle navigation system of claim 14, wherein the vehicle mounted display and the portable display display different information about the location of the GPS unit relative to the predetermined locations.

18. A vehicle navigation system comprising:
a. a vehicle;
b. a vehicle mounted data display attached to the vehicle and viewable by an operator of the vehicle;
c. a portable GPS unit including a GPS sensor, a central processing unit for storing a plurality of locations, and a portable display, the GPS sensor being for sensing the location of the GPS unit;
d. a mounting point on the vehicle configured for mounting the GPS unit so that the portable data display is viewable by the operator of the vehicle; and
e. a data interface between the portable GPS unit and the vehicle mounted display so that data from the portable GPS unit may be displayed on the vehicle mounted display;
f. wherein the vehicle mounted display and the portable display display different information about the location of the GPS unit relative to the stored locations.

19. The vehicle navigation system of claim 18, wherein a navigation program is stored on the central processing unit.

20. The vehicle navigation system of claim 18, further comprising vehicle controls for controlling the operation of the vehicle and an input device that is configured to send a signal to the GPS unit through the data interface, wherein the input device is located so that the operator may activate it without removing a hand from the vehicle steering controls.

21. The vehicle navigation system of claim 18, an input device that is configured to send a signal to the GPS unit through the data interface, wherein the input device is located on the vehicle mounted data display.

22. The vehicle navigation system of claim 21, wherein the input device is configured to send a signal to the GPS unit to store the position of the GPS unit in the central processing unit.

23. The vehicle navigation system of claim 20, wherein the input device is configured to send a signal to the GPS unit to store the position of the GPS unit in the central processing unit.

24. The vehicle navigation system of claim 18, wherein the data interface further comprises a serial port and wires.

25. A vehicle navigation system comprising:
a. a vehicle;
b. a vehicle mounted data display attached to the vehicle and viewable by an operator of the vehicle;
c. a portable GPS unit including a GPS sensor for sensing the location of the GPS unit, a central processing unit for automatically storing the location of the unit at defined time intervals, and a portable display;
d. a mounting point on the vehicle configured for mounting the GPS unit so that the portable data display is viewable by the operator of the vehicle; and
e. a data interface between the portable GPS unit and the vehicle mounted display so that data from the portable GPS unit may be displayed on the vehicle mounted display;
f. wherein the vehicle mounted display and the portable display display different information about the location of the GPS unit relative to the stored locations.

26. The vehicle navigation system of claim 25, wherein a navigation program is stored on the central processing unit.

27. The vehicle navigation system of claim 26, wherein the central processing unit creates a record of the GPS unit's location over time by automatically storing a plurality of locations at defined time intervals.

28. The vehicle navigation system of claim 27, further comprising an input device configured to activate the automatic storing of the GPS unit's location.

29. The vehicle navigation system of claim 28, further comprising vehicle controls for controlling the operation of the vehicle, wherein the input device is located so that the operator may activate it without removing a hand from the vehicle steering controls.

30. The vehicle navigation system of claim 27, further comprising an input device configured to send a signal to the GPS unit to store the position of the GPS unit in the central processing unit.

31. The vehicle navigation system of claim 30, further comprising vehicle steering controls for controlling the operation of the vehicle, wherein the input device is located so that the operator may activate it without removing a hand from the vehicle steering controls.

32. The vehicle navigation system of claim 25, wherein the data interface further comprises a serial port and wires.

33. The vehicle navigation system of claim 28, wherein the input device is located on the vehicle mounted data display.

34. The vehicle navigation system of claim 30, wherein the input device is located on the vehicle mounted data display.

35. A vehicle navigation system comprising;
a. a vehicle;
b. a vehicle mounted sensor for sensing an operating parameter of the vehicle;
c. a vehicle mounted data display attached to the vehicle for displaying data from the vehicle mounted sensor and is viewable by an operator of the vehicle;
d. a portable GPS unit including a GPS sensor for sensing the location of the GPS unit and also including a portable display; and
e. a data interface between the portable GPS unit and the vehicle mounted display;
f. wherein the vehicle mounted data display dispalys data from the portable GPS unit when receiving data from the data interface and displays data from the vehicle mounted sensor when the data interface with the GPS unit is interrupted.

36. A vehicle navigation system comprising;
a. a vehicle having an engine, a straddle-type seat, running boards, at least one drive track, and a pair of ground-engaging skis;
b. a vehicle mounted sensor for sensing an operating parameter of the vehicle;
c. a portable GPS unit including a GPS sensor for sensing the location of the GPS unit and also having a portable display; and
d. a data interface between the portable GPS unit and the vehicle mounted display so that data from the portable GPS unit may be displayed on the vehicle mounted display.

37. The vehicle navigation system of claim 36, further comprising a mounting point on the vehicle configured for mounting the GPS unit so that the portable data display is viewable by the operator of the vehicle.

38. The vehicle navigation system of claim 36, wherein the portable GPS unit may be located proximate to the vehicle mounted display.

39. The vehicle navigation system of claim 38, wherein the data interface further comprises a serial port and wires.

40. The vehicle navigation system of claim 39, wherein the serial port further comprises a RS-232 port.

41. The vehicle navigation system of claim 38, wherein the data interface comprises a wireless interface.
